(19) United States
(12) Patent Application Publication
(10) Pub. No.: US 2026/0052408 A1
(43) Pub. Date: Feb. 19, 2026

(54) OPTIMIZATION OF INTER-FREQUENCY MEASUREMENT WITHOUT MEASUREMENT GAP FOR REDUCED CAPABILITY USER EQUIPMENT

(71) Applicant: Apple Inc., Cupertino, CA (US)

(72) Inventors: Jie Cui, San Jose, CA (US); Dawei Zhang, Saratoga, CA (US); Haitong Sun, Cupertino, CA (US); Hong He, San Jose, CA (US); Manasa Raghavan, Sunnyvale, CA (US); Qiming LI, Beijing (CN); Xiang Chen, Campbell, CA (US); Yang Tang, San Jose, CA (US); Yushu Zhang, Beijing (CN)

(21) Appl. No.: 19/101,765

(22) PCT Filed: Aug. 11, 2023
(86) PCT No.: PCT/US2023/030043

§ 371 Date: Feb. 6, 2025

Related U.S. Application Data
(60) Provisional application No. 63/397,381, filed on Aug. 11, 2022.

(51) Int. Cl. H04W 24/08

(52) U.S. Cl. CPC H04W 24/08

(57) ABSTRACT

Methods, systems, and computer readable media for reference synchronization signal/physical broadcast channel block (SSB) signal measurement are disclosed. In one aspect, the method can include actions of determining, by a UE, whether a level of SSB block measurement timing configuration (SMTC) overlap for inter-frequency measurement without measurement gap (MG) without capability is (i) partially overlapped or (ii) fully nonoverlapped with a MG configured by a serving cell, and determining, by the UE, whether to perform inter-frequency measurement without measurement gap (MG) without capability within the MG or outside of the MG based on the determined level of SMTC overlap.

### CROSS-REFERENCE TO RELATED APPLICATIONS

The present application claims priority to U.S. Prov. App. No. 63/397,381, filed on Aug. 11, 2022, entitled “OPTIMIZATION OF INTER-FREQUENCY MEASUREMENT WITHOUT MEASUREMENT GAP FOR REDUCED CAPABILITY USER EQUIPMENT,” which is incorporated herein by reference in its entirety.

### BACKGROUND

Intra-frequency measurement and inter-frequency measurement operations are performed by user equipment to facilitate a variety of wireless network operations such as user equipment (UE) handover. Such measurement operations can be performed based on a reference SS/PBCH block (SSB).

### SUMMARY

According to one innovative aspect of the present disclosure, a method for reference synchronization signal/physical broadcast channel block (SSB) signal measurement is disclosed. In one aspect, the method can include actions of determining, by a UE, whether a level of SSB block measurement timing configuration (SMTC) overlap for inter-frequency measurement without measurement gap (MG) without capability is (i) partially overlapped or (ii) fully non-overlapped with a MG configured by a serving cell, and determining, by the UE, whether to perform inter-frequency measurement without measurement gap (MG) without capability within the MG or outside of the MG based on the determined level of SMTC overlap with the MG configured by the serving cell.

Other aspects include apparatuses, systems, and computer programs for performing the actions of the aforementioned method.

The innovative method can include other optional features. For example, in some implementations, method further can further include determining, by the UE, that the level of SMTC overlap is partially overlapped with the MG configured by the serving cell, and based on the determination, by the UE, that the level of SMTC overlap is partially overlapped with the MG configured by the serving cell, performing, by the UE, inter-frequency measurement without measurement gap (MG) without capability within the MG.

In some implementations, the method can further include determining, by the Red Cap UE, that the level of SMTC overlap is partially overlapped with the MG configured by the serving cell, and based on the determination, by the UE, that the level of SMTC overlap is partially overlapped with the MG configured by the serving cell, performing, by the UE, inter-frequency measurement without measurement gap (MG) without capability outside the MG.

In some implementations, the method can further include determining, by the UE, that the level of SMTC overlap is partially overlapped with the MG configured by the serving cell, based on the determination, by the UE, that the level of SMTC overlap is partially overlapped with the MG configured by the serving cell, determining, by the UE, whether a flag indicating whether the UE is configured to perform inter-frequency measurement without gap is activated, and based on the determination, by the UE, that the flag indicating whether the UE is configured to perform inter-frequency measurement without gap is activated, performing, by the UE, inter-frequency measurement without measurement gap (MG) without capability outside the MG.

In some implementations, the method can further include determining, by the UE, that the level of SMTC overlap is partially overlapped with the MG configured by the serving cell, based on the determination, by the UE, that the level of SMTC overlap is partially overlapped with the MG configured by the serving cell, determining, by the UE, whether a flag indicating whether the UE is configured to perform inter-frequency measurement without gap not activated, and based on the determination, by the UE, that the flag indicating whether the UE is configured to perform inter-frequency measurement without gap is not activated, performing, by the UE, inter-frequency measurement without measurement gap (MG) without capability within the MG.

In some implementations, the method can further include determining, by the UE, that the level of SMTC overlap is partially overlapped with the MG configured by the serving cell, based on the determination, by the UE, that the level of SMTC overlap is partially overlapped with the MG configured by the serving cell, determining, by the UE, whether an interFrequencyConfig-NoGap for interfrequency measurement without MG without capability value is activated, and based on the determination, by the UE, that the interFrequencyConfig-NoGap for interfrequency measurement without MG without capability value is activated, performing, by the UE, inter-frequency measurement without measurement gap (MG) without capability outside the MG.

In some implementations, the method can further include determining, by the UE, that the level of SMTC overlap is partially overlapped with the MG configured by the serving cell, based on the determination, by the UE, that the level of SMTC overlap is partially overlapped with the MG configured by the serving cell, determining, by the UE, whether an interFrequencyConfig-NoGap for interfrequency measurement without MG without capability value is not activated, and based on the determination, by the UE, that the interFrequencyConfig-NoGap for interfrequency measurement without MG without capability value is not activated, performing, by the UE, inter-frequency measurement without measurement gap (MG) without capability within the MG.

In some implementations, the method can further include determining, by the UE, that the level of SMTC overlap is fully non-overlapped with the MG configured by the serving cell, and based on the determination, by the UE, that the level of SMTC overlap is fully non-overlapped with the MG configured by the serving cell, immediately performing, by the UE, inter-frequency measurement without measurement gap (MG) without capability.

In some implementations, the method can further include determining, by the UE, that the level of SMTC overlap is fully non-overlapped with the MG configured by the serving cell, and based on the determination, by the UE, that the level of SMTC overlap is fully non-overlapped with the MG configured by the serving cell, delaying performance, by the UE, of inter-frequency measurement without measurement gap (MG) without capability until the network reconfigures the SMTC to partially overlapped or fully overlapped with MG.

In some implementations, the method can further include determining, by the UE, that the level of SMTC overlap is fully non-overlapped with the MG configured by the serving cell, based on the determination, by the UE, that the level of SMTC overlap is fully non-overlapped with the MG configured by the serving cell, determining, by the UE, whether a flag indicating whether the UE is configured to perform inter-frequency measurement without gap is activated, and based on the determination, by the UE, that the flag indicating whether the UE is configured to perform inter-frequency measurement without gap is activated, immediately performing, by the UE, inter-frequency measurement without measurement gap (MG) without capability.

In some implementations, the method can further include determining, by the UE, that the level of SMTC overlap is fully non-overlapped with the MG configured by the serving cell, based on the determination, by the UE, that the level of SMTC overlap is fully non-overlapped with the MG configured by the serving cell, determining, by the UE, whether a flag indicating whether the UE is configured to perform inter-frequency measurement without gap is not activated, and based on the determination, by the UE, that the flag indicating whether the UE is configured to perform inter-frequency measurement without gap is not activated, delaying performance, by the UE, of inter-frequency measurement without measurement gap (MG) without capability until the network reconfigures the SMTC to partially overlapped or fully overlapped with MG.

In some implementations, the method can further include determining, by the UE, that the level of SMTC overlap is fully non-overlapped with the MG configured by the serving cell, based on the determination, by the UE, that the level of SMTC overlap is fully non-overlapped with the MG configured by the serving cell, determining, by the UE, whether an interFrequencyConfig-NoGap for interfrequency measurement without MG without capability value is activated, and based on the determination, by the UE, that the interFrequencyConfig-NoGap for interfrequency measurement without MG without capability value is activated, immediately performing, by the UE, inter-frequency measurement without measurement gap (MG) without capability.

In some implementations, the method can further include determining, by the UE, that the level of SMTC overlap is fully non-overlapped with the MG configured by the serving cell, based on the determination, by the UE, that the level of SMTC overlap is fully non-overlapped with the MG configured by the serving cell, determining, by the UE, whether an interFrequencyConfig-NoGap for interfrequency measurement without MG without capability value is not activated, and based on the determination, by the UE, that the interFrequencyConfig-NoGap for interfrequency measurement without MG without capability value is not activated, delaying performance, by the UE, of inter-frequency measurement without measurement gap (MG) without capability until the network reconfigures the SMTC to partially overlapped or fully overlapped with MG. According to another innovative aspect of the present disclosure, a method for determining a value of one or more carrier-specific scaling factors (CSSFs) by a UE for SSB-based measurements is disclosed. In one aspect, the method can include actions of determining, by the UE, a number of measurement objects to be measured, determining, by the UE, whether an intra-frequency measurement is inside active bandwidth part (BWP) and without a measurement gap (MG) or outside an active BWP and within the MG, and setting, by the UE, the value of the one or more CSSFs based on the (i) determined number of measurement objects to be measured and (ii) the determination as to whether the intra-frequency measurement is inside the active BWP or outside the active BWP.

Other aspects include apparatuses, systems, and computer programs for performing the actions of the aforementioned method.

The innovative method can include other optional features. For example, in some implementations, determining, by the UE, a number of measurement objects to be measured within measurement gap (MG) can include determining, by the UE that only one measurement object is configured to be measured outside of MG for RedCap. In such implementations, setting, by the UE, the value of the one or more CSSFs based on the (i) determined number of measurement objects to be measured and (ii) the determination as to whether the intra-frequency measurement is inside the active BWP or outside the active BWP can include based on a determination, by the UE, that only one measurement object is to be measured outside of MG, setting the value of one CSSF equal to 1.

In some implementations, determining, by the UE, whether an intra-frequency measurement is inside active bandwidth part and without MG or outside an active BWP and within MG can include determining that the intra-frequency measurement is inside the active BWP. In such implementations, setting, by the UE, the value of the one or more CSSFs based on the (i) determined number of measurement objects to be measured and (ii) the determination as to whether the intra-frequency measurement is inside the active BWP or outside the active BWP can include based on a determination, by the UE, that the intra-frequency measurement is inside the active BWP, (i) setting the value of a first CSSF to 2 for the intra-frequency measurement and (ii) setting the value of a second CSSF to 2*Y for interfrequency measurement with no measurement gap, where Y is the number of interfrequency measurement objects without MG that are being measured outside of MG.

In some implementations, the number of interfrequency measurement objects without MG that are being measured outside of MG include (i) interfrequency measurement without MG with capability measurement objects and (ii) interfrequency measurement without MG without capability measurement objects.

In some implementations, determining, by the UE, whether an intra-frequency measurement is inside active bandwidth part (BWP) and without MG or outside an active BWP and within MG can include determining that the intra-frequency measurement is outside the active BWP. In such implementations, setting, by the UE, the value of the CSSF based on the (i) determined number of measurement objects to be measured and (ii) the determination as to whether the intra-frequency measurement is inside the active BWP or outside the active BWP can include based on a determination, by the UE, that the intra-frequency measurement is outside the active BWP, setting the value of one CSSF to Y for interfrequency measurement with no measurement gap, where Y is the number of interfrequency measurement objects without MG that are being measured outside of MG.

In some implementations, determining, by the UE, whether an intra-frequency measurement is inside active bandwidth part (BWP) and without MG or outside an active BWP and within MG can include determining that the intra-frequency measurement is inside the active BWP. In such implementations, setting, by the UE, the value of the one or more CSSFs based on the (i) determined number of measurement objects to be measured and (ii) the determination as to whether the intra-frequency measurement is inside the active BWP or outside the active BWP can include based on a determination, by the UE, that the intra-frequency measurement is inside the active BWP, (i) setting the value of a first CSSF to 2 for the intra-frequency measurement, (ii) setting the value of a second CSSF to 2*(1/X)*Y for interfrequency measurement without measurement gap with capability, where Y is the number of interfrequency measurement objects without MG with capability that are being measured outside of MG, and (iii) setting the value of a third CSSF to 2*(1/(1-X))*Z for inter-frequency without MG without capability, where Z is the number of interfrequency measurement objects without MG without capability that are being measured outside of MG, where X is a resource sharing factor between (a) interfrequency measurements of measurement objects without MG with capability and (b) interfrequency measurement of measurement objects without MG without capability.

In some implementations, X is equal to 0.5.

In some implementations, X is preconfigured via signaling received from a gNodeB.

In some implementations, determining, by the UE, whether an intra-frequency measurement is inside active bandwidth part (BWP) and without MG or outside an active BWP and within MG can include determining that the intra-frequency measurement is outside the active BWP. In such implementations, setting, by the UE, the value of the one or more CSSFs based on the (i) determined number of measurement objects to be measured and (ii) the determination as to whether the intra-frequency measurement is inside the active BWP or outside the active BWP can include based on a determination, by the UE, that the intra-frequency measurement is outside the active BWP, (i) setting the value of a first CSSF to (1/X)*Y for interfrequency measurement without measurement gap with capability, where Y is the number of interfrequency measurement objects without MG with capability that are being measured outside of MG, and (iii) setting the value of a second CSSF to (1/1-X))*Z for inter-frequency without MG without capability, where Z is the number of interfrequency measurement objects without MG without capability that are being measured outside of MG, where X is a resource sharing factor between (a) interfrequency measurements of measurement objects without MG with capability and (b) interfrequency measurement of measurement objects without MG without capability.

In some implementations, X is equal to 0.5.

In some implementations, X is preconfigured via signaling received from a gNodeB.

These and other innovative aspects of the present disclosure are described in more detail below in detail description, the drawings, and/or the accompanying claims.

### BRIEF DESCRIPTION OF THE DRAWINGS

FIG. 1 is a conceptual diagram of concepts related to inter-frequency measurement without measurement gap (MG) for reduced capability (RedCap) user equipment (UE).

FIG. 2 is a flowchart of a process for optimizing inter-frequency measurement without measurement gap for RedCap UEs.

FIG. 3 is a flowchart of a process for deriving one or more carrier-specific scaling factors (CSSFs) for intrafrequency or interfrequency SSB-based measurement.

FIG. 4 is an example of a wireless communication system.

FIG. 5 is a block diagram of an example of user equipment (UE).

FIG. 6 is a block diagram of an example of an access node.

Like reference symbols in the various drawings indicate like elements.

### DETAILED DESCRIPTION

As New Radio (NR) fifth generation (5G) and future communication standards develop, network flexibility and scalability can adapt new use cases to connect more devices, for example, reduced capability (RedCap) user equipments (UE) or devices. RedCap UEs can be UE devices with reduced capabilities including wearable devices, sensors, or other devices that have less stringent data requirements compared to, for example, enhanced mobile broadband (eMBB) devices. As such, a RedCap UE may have reduced frequency bandwidths that require accommodations in subcarrier spacing for synchronization signal block/physical broadcast channel block (SSB) used for cell search, selection, re-selection, and handover procedures. As such, the network (NW) can allocate different system bandwidths for RedCap UEs and non-RedCap UEs.

With different system bandwidths for RedCap UEs and non-RedCap UEs, transmission of legacy SSBs, or cell-defined-SSBs (CD-SSBs), on an active bandwidth part (BWP) in the system bandwidth for non-RedCap UEs may potentially result in CD-SSBs being transmitted outside of an active BWP used by a RedCap UE due to different system bandwidth for the RedCap UE. In such instances, this may require the RedCap UE to tune to frequency bands outside of an active BWP of the RedCap UE to perform SSB measurements, resulting in performance degradation or power consumption. Accordingly, a second type of SSB, i.e., non-cell-defined-SSB (NCD-SSB), may be introduced for dedicated use by RedCap UEs to address this issue. With the coexistence of multiple SSB types, however, there may be instances where a UE detects either or both CD-SSBs and NCD-SSB, and solutions are disclosed herein for addressing UE and network operations when both CD-SSB and NCD-SSB are configured for a serving cell and/or a neighbor cell.

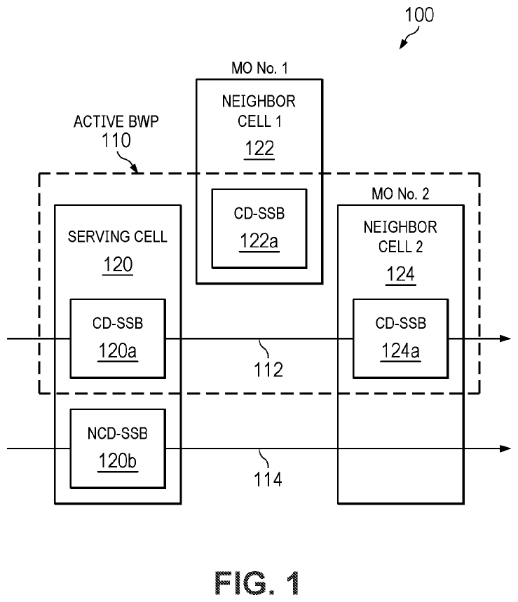

FIG. 1 is a conceptual diagram 100 of concepts related to inter-frequency measurement without measurement gap (MG) for reduced capability (RedCap) user equipment (UE). In general, MGs are required if a UE is requested to perform measurements which cannot be completed while the UE is tuned to the current serving cell 120. In such instances, a MG is an amount of time required to re-tune the transceiver of a UE to the target cell carrier, complete the measurement, and then re-tune to the original cell carrier. As such, MGs can impact performance because they interrupt both uplink and downlink transfer. Accordingly, it is beneficial to avoid MGs when practicable.

For purposes of this disclosure, measurements “within the MG” or “with MG” are measurements that require a MG. In contrast, measurements “outside of MG” or “without MG”do not require MG.

The diagram 100 displays an active bandwidth part 110 of a carrier, a reference SSB blocks 120a, 120b of a serving cell 120, a reference SSB 122a of a first measurement object 122 of a first neighboring cell, and a reference SSB 124b of a second measurement object 124 of a second neighboring cell.

Because the UE of the service cell 120 is a RedCap UE, multiple SSBs are provided including a CD-SSB 120a and an NCD-SSB. In contrast, the neighboring cells 122 and 124 are only broadcasting a single SSB for each cell-i.e., CD-SSB 122a and CD-SSB 122b, respectively. Diagram 100 also displays the frequency layer 112 used by the serving cell 120 to broadcast the CD-SSB 120a and the frequency layer 114 used by the serving cell 120 to broadcast the NCD-SSB 114.

As illustrated, a RedCap UE may have multiple SSB 120a, 120b options to measure, the network (e.g., gNodeB) indicates which SSB block is to be used for measurement. For example, the network can use parameter such as BWP-specific service CellMO under BWP-DownlinkDedicated of active DLBWP to indicate the particular SSB of multiple SSBs 120a, 120b to be used for measurement.

Regarding the first measurement object 122, the first measurement object's 122 SSB 122a is within the same active BWP 110 of the RedCap UE in serving cell 120. However, the first measurement object's 122 SSB 122a is on a different frequency layer of the active BWP 110 from the serving cell's 120 CD-SSB 120a. In this scenario, if the network indicates that CD-SSB is the reference SSB inside the active BWP 110 and the measurement object falls within the RedCap UE's active BWP 110, then measurement of the first measurement object 122 (the measurement object No.1 122) is an inter-frequency measurement without measurement gap (MG) with capability. This scenario can be referred to, herein, as having an SSB Measurement Timing Configuration (SMTC) window that is fully non-overlapped, as the SSB 122a of the first measurement object is not overlapping with any measurement gap occasion configured by the serving cell 120.

Regarding the second measurement object 124, the second measurement object's 124 SSB 124b is within the active BWP 110 of the RedCap UE in the serving cell and on the same frequency layer 112 of the active BWP 110 of the RedCap UE in the service cells. However, in this example, the serving cell 120 provides two SSBs blocks—i.e., a CD-SSB 120a and an NCD-SSB 120b. Accordingly, the network (e.g., a gNodeB) informs a RedCap UE as to the SSB that is to be used as a reference SSB. In this example, even though the CD-SSB 124b overlaps with the CD-SSB 120a within the active BWP 110 and on the same frequency layer 112 as the RedCap UE of the serving cell 120, if the network indicates that the NCD-SSB 120b is the reference SSB, the RedCap UE's measurement of the second measurement object 124 (the measurement object No.2 124) is an inter-frequency measurement without MG. This is because the network has indicated that the reference SSB block of the serving cell is the NCD-SSB 120b, which is outside of the active BWP 110 and on a different frequency layer 114 than the CD-SSB 124b of the second measurement object 124. In such implementations, the measurement is performed without MG regardless of capability of the UE. This scenario can be referred to, herein, as having an SSB Measurement Timing Configuration (SMTC) window that is partially overlapping, as some but not all SSB 124a of the measurement object overlaps with at least one of the measurement gap occasion configured by the serving cell.

In either of the aforementioned scenarios, if the network does not indicate the SSB that is to be used as a reference SSB, then the RedCap UE will default to the legacy implementation and use the CD-SSB 120a as the reference SSB.

For purposes of this disclosure, the phrase “with capability” means its an optional feature for UE. Thus, UE can use this capability indication to either support or not support this measurement without MG. In contrast, “without capability” means as long as conditions of UE to support measurement without MG without capability is met, UE is mandated to support measurement without MG.

The condition of UE to support measurement without MG without capability, is: if serving cell NCD-SSB is used as reference SSB and it is outside an active BWP, and serving cell CD-SSB is inside active BWP; the neighbor cell measurement on the CD-SSB (same frequency as serving cell CD-SSB) is an inter-frequency measurement without MG without capability.

### Network Flags For Condition Based Interfrequency Measurement without MG

### Partially Overlapped SMTC Case

In a first case, a RedCap UE can determine that the SMTC window that is partially overlapped with MGs and that the network (e.g., gNodeB) indicates that the RedCap UE is configured to perform interfrequency measurement without MG. The network can indicate that the RedCap UE is configured to perform interfrequency measurement without MG using a flag such as, for example, an interFrequencyConfig-NoGap flag. However, the present disclosure should not be limited to use of this particular flag. Instead, any flag indicating whether the UE is configured to perform inter-frequency measurement without gap can be used in the same manner herein as the interFrequencyConfig-NoGap is used in the examples below.

In some implementations of the first case, the RedCap UE is configured to always perform interfrequency measurement without MG without capability of a measurement object within the MG, regardless of the interFrequencyConfig-NoGap flag. Alternatively, in other implementations of the first case, the RedCap UE is always configured to perform interfrequency measurement without MG without capability of a measurement object outside the MG, regardless of the interFrequencyConfig-NoGap flag. Alternatively, in other implementations of the first case, the RedCap UE is configured to perform interfrequency measurement without MG without capability if the interFrequencyConfig-NoGap flag is activated (e.g., set to true); otherwise, the RedCap UE is configured to always perform interfrequency measurement without MG without capability within the MG.

In yet another implementation of the first case, new network signaling can be employed by the network that includes a network flag which can be referred to, for example, interFrequencyConfig-NoGap for interfrequency measurement without MG without capability. In this first case, the flag interFrequencyConfig-NoGap for inter frequency measurement without MG without capability is any parameter or signal that causes a RedCap UE to perform interfrequency measurement without MG without capability when activated. In such implementations, the interFrequencyConfig-NoGap flag can only control interfrequency measurement without measurement gap with capability inside or outside MG. And, then, if the interFrequencyConfig-NoGap for interfrequency measurement without MG without capability flag is activated (e.g., set to true), the RedCap UE will perform interfrequency measurement without measurement gap without capability outside the MG; otherwise, the RedCap UE would always perform interfrequency measurement gap without capability within the MG.

### Fully Non-Overlapped SMTC Case

In a second case, a RedCap UE can determine that the SMTC window that is fully non-overlapped with MGs and that the network (e.g., gNodeB) indicates that the RedCap UE is configured to perform interfrequency measurement without MG. The network can indicate that the RedCap UE is configured to perform interfrequency measurement without MG using, for example, an interFrequencyConfig-NoGap flag.

In some implementations of the second case, the RedCap UE is configured to always perform interfrequency measurement without MG without capability immediately, regardless of the interFrequencyConfig-NoGap flag. In the context of the second case, the word “immediately” means without MG and without waiting for a network reconfiguration. Alternatively, in other implementations of the second case, the RedCap UE is configured to delay performance of interfrequency measurement without MG without capability until the network (e.g., gNodeB) reconfigures the SMTC window to partially overlapped or fully overlapped, regardless of the interFrequencyConfig-NoGap flag. Alternatively, in other implementations of the second case, the RedCap UE is configured to perform interfrequency measurement without MG without capability immediately if the interFrequencyConfig-NoGap flag is activated (e.g., set to true); otherwise, the RedCap UE is configured to delay performance of interfrequency measurement without MG without capability until the network (e.g., gNodeB) reconfigures the SMTC window to partially overlapped or fully overlapped.

In yet another implementation of the second case, new network signaling can be employed by the network that includes a network flag which can be referred to, for example, as interFrequencyConfig-NoGap for interfrequency measurement without MG without capability. In this second case, the flag interFrequencyConfig-NoGap for interfrequency measurement without MG without capability is any parameter or signal that causes a RedCap UE to perform interfrequency measurement without MG without capability immediately when activated. In such implementations, the interFrequencyConfig-NoGap flag can only control interfrequency measurement without measurement gap with capability. And, then, if the inter FrequencyConfig-NoGap for interfrequency measurement without MG without capability flag is activated (e.g., set to true), the RedCap UE will perform interfrequency measurement without measurement gap without capability immediately; otherwise, the RedCap UE is configured to delay performance of interfrequency measurement without MG until the network (e.g., gNodeB) reconfigures the SMTC window to partially overlapped or fully overlapped.

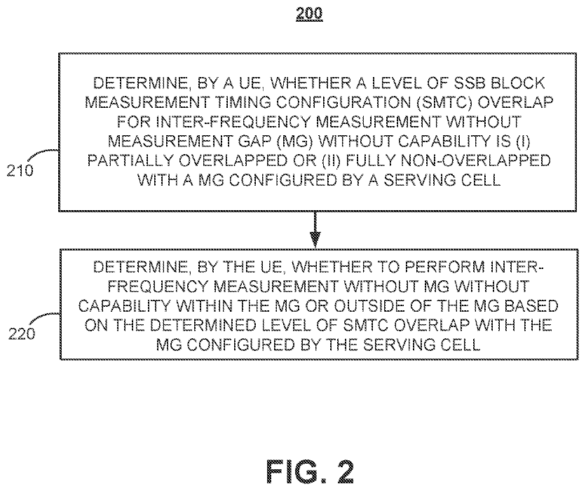

FIG. 2 is a flowchart of a process 200 for optimizing inter-frequency measurement without measurement gap for RedCap UEs. The process will be described below as being performed by a UE.

A UE can begin execution of the process 200 by determining whether a level of SSB block measurement timing configuration (SMTC) overlap for inter-frequency measurement without measurement gap (MG) without capability is (i) partially overlapped or (ii) fully non-overlapped with a MG configured by a serving cell (210). In some implementations, the UE's execution of stage 210 can include the UE determining that the level of SMTC overlap is partially overlapped with the MG by the serving cell. In some implementations, the UE's execution of stage 210 can include the UE determining that the level of SMTC overlap is fully non-overlapped with MG configured by the serving cell.

The UE can continue execution of the process 200 by determining whether to perform inter-frequency measurement without measurement gap (MG) without capability within the MG or outside of the MG based on the determined level of SMTC overlap with the MG configured by the serving cell (220).

### Continuation of Process 200 When SMTC Window is Partially Overlapped

In some implementations, the UE's execution of stage 220 can include based on a determination at stage 210, by the UE, that the level of SMTC overlap is partially overlapped with the MG configured by the serving cell, the UE can continue execution of the process 200 by performing inter-frequency measurement without measurement gap (MG) without capability within the MG.

In some implementations, the UE's execution of stage 220 can include based on a determination at stage 210, by the UE, that the level of SMTC overlap is partially overlapped with the MG configured by the serving cell, the UE can continue execution of the process 200 by performing, by the UE, inter-frequency measurement without measurement gap (MG) without capability outside the MG.

In some implementations, based on a determination at stage 210, by the UE, that the level of SMTC overlap is partially overlapped with the MG configured by the serving cell, the UE can continue execution of the process 200 by determining whether an interFrequencyConfig-NoGap value is activated. Based on a determination, by the UE, that the interFrequencyConfig-NoGap value is activated, the UE can continue execution of the process 200 by performing inter-frequency measurement without measurement gap (MG) without capability outside the MG.

In some implementations, based on a determination at stage 210, by the UE, that the level of SMTC overlap is partially overlapped with the MG configured by the serving cell, the UE can continue execution of the process 200 by determining whether an interFrequencyConfig-NoGap value is not activated. Based on a determination, by the RedCap UE, that the interFrequencyConfig-NoGap value is not activated, the UE can continue execution of the process 200 by performing inter-frequency measurement without measurement gap (MG) without capability within the MG.

In some implementations, based on a determination at stage 210, by the UE, that the level of SMTC overlap is partially overlapped with the MG configured by the serving cell, the UE can continue execution of the process 200 by determining whether an interFrequencyConfig-NoGap for interfrequency measurement without MG without capability value is activated. Based on a determination, by the UE, that the interFrequencyConfig-NoGap for interfrequency measurement without MG without capability value is activated, the UE can continue execution of the process 200 by performing inter-frequency measurement without measurement gap (MG) without capability outside the MG.

In some implementations, based on a determination at stage 210, by the UE, that the level of SMTC overlap is partially overlapped with the MG configured by the serving cell, the UE can continue execution of the process 200 by determining whether an interFrequencyConfig-NoGap for interfrequency measurement without MG without capability value is not activated. Based on a determination, by the UE, that the interFrequencyConfig-NoGap for interfrequency measurement without MG without capability value is not activated, the UE can continue execution of the process 200 by performing inter-frequency measurement without measurement gap (MG) without capability within the MG.

### Continuation of Process 200 When SMTC Window is Fully Non-Overlapped

In some implementations, the UE's execution of stage 220 can include based on the determination at stage 210, by the UE, that the level of SMTC overlap is fully non-overlapped with the MG configured by the serving cell, the UE can continue execution of the process 200 by immediately performing inter-frequency measurement without measurement gap (MG) without capability.

In some implementations, the UE's execution of stage 220 can include based on the determination at stage 210, by the UE, that the level of SMTC overlap is fully non-overlapped with the MG configured by the serving cell, the UE can continue execution of the process 200 by delaying performance of inter-frequency measurement without measurement gap (MG) without capability until the network reconfigures the SMTC to partially overlapped or fully overlapped with MG.

In some implementations, based on a determination at stage 210, by the UE, that the level of SMTC overlap is fully non-overlapped with the MG configured by the serving cell, the UE can continue execution of the process 200 by determining whether an interFrequencyConfig-NoGap value is activated. Based on a determination, by the UE, that the interFrequencyConfig-NoGap value is activated, the UE can continue execution of the process 200 by immediately performing, by inter-frequency measurement without measurement gap (MG) without capability.

In some implementations, based on a determination at stage 210, by the UE, that the level of SMTC overlap is fully non-overlapped with the MG configured by the serving cell, the UE can continue execution of the process 200 by determining whether an interFrequencyConfig-NoGap value is not activated Based on a determination, by the UE, that the interFrequencyConfig-NoGap value is not activated, the UE can continue execution of the process 200 by delaying performance of inter-frequency measurement without measurement gap (MG) without capability until the network reconfigures the SMTC to partially overlapped or fully overlapped with MG.

In some implementations, based on a determination at stage 210, by the UE, that the level of SMTC overlap is fully non-overlapped with the MG configured by the serving cell, the UE can continue execution of the process 200 by determining whether an interFrequencyConfig-NoGap for interfrequency measurement without MG without capability value is activated. Based on a determination, by the UE, that the interFrequencyConfig-NoGap for interfrequency measurement without MG without capability value is activated, the UE can continue execution of the process 200 by performing inter-frequency measurement without measurement gap (MG) without capability.

In some implementations, based on a determination at stage 210, by the UE, that the level of SMTC overlap is fully non-overlapped with the MG configured by the serving cell, the UE can continue execution of the process 200 by determining whether an interFrequencyConfig-NoGap for interfrequency measurement without MG without capability value is not activated. Based on a determination, by the UE, that the interFrequencyConfig-NoGap for interfrequency measurement without MG without capability value is not activated, the UE can continue execution of the process 200 by delaying performance of inter-frequency measurement without measurement gap (MG) without capability until the network reconfigures the SMTC to partially overlapped or fully overlapped with MG.

### Carrier Specific Scaling Factor (CSSF) for SSB Measurements

The CSSF is a parameter that can be used, by a UE to allocate resources for intrafrequency SSB-based measurement and interfrequency SSB-based measurement. By way of example, if the CSSF if set to 1, then 100% of the resources are allocated to SSB-based measurement of a single measurement object. In the alternative, if the CSSF is set to a value greater than 1, then the set of available resources for SSB-based measurement is scaled (e.g., divisible by) the CSSF value.

In some implementations, for UE in stand alone (SA) operation mode, the carrier-specific scaling factor for intra-frequency SSB-based measurements outside MG, inter-frequency SSB-based measurements performed outside measurements gaps, which may be annotated as, e.g., CSSF_{outside_gap_RedCap,i,} will be specified as CSSF_{outside_gap_RedCap,i}=1, if only one measurement object is configured to be measured outside of MG for RedCap.

In the alternative, to the aforementioned case of one measurement object that is configured to measured outside of MG for RedCap, two different configurations may be employed.

In a first configuration, if, for example, intra-frequency measurement is inside active BWP or without MG, then the CSSF_{outside_gap_RedCap,i}=2 for this intra-frequency measurement, as the UE searcher occupancy rate for this intra-frequency without MG is 50%. In addition, CSSF_{outside_gap_RedCap,i}=2*Y for inter-frequency measurement with no measurement gap, Y is the number of configured inter-frequency MOs without MG that are being measured outside of MG including type A and type B measurements.

Alternatively, if, the first configuration, intra-frequency measurement is outside active BWP or with MG, then CSSF_{outside_gap_RedCap,i}=Y for inter-frequency measurement with no measurement gap, the UE searcher is occupied for this inter-frequency without MG including type A and type B measurements. In this alternative, Y is the number of configured inter-frequency MOs without MG that are being measured outside of MG including type A and type B measurements.

In a second configuration, if, for example, intra-frequency measurement is inside active BWP or without MG (measurement gap), then CSSF_{outside_gap_RedCap,i}=2 for this intra-frequency measurement, as the UE searcher occupancy rate for this intra-frequency without MG is 50%. In addition, CSSF_{outside_gap_RedCap,i}=2*(1/X)*Y for inter-frequency type A measurement, where Y is the number of configured type A MOs without MG that are being measured outside of MG. In addition, CSSF_{outside_gap_RedCap,i}=2*(1/(1-X))*Z for inter-frequency type B measurement, where Z is the number of configured type B MOs without MG that are being measured outside of MG and X is the searcher resource sharing factor between type A and type B. In some implementations, for example, X can be equal to 50%.

Alternatively, if, in the second configuration, intra-frequency measurement is outside active BWP or with MG, then CSSF_{outside_gap_RedCap,i}=(1/X)*Y for inter-frequency type A measurement, as the UE searcher is occupied for this inter-frequency without MG including type A and type B measurements. In this alternative second configuration, Y is the number of configured type A MOs without MG that are being measured outside of MG and CSSF_{outside_gap_RedCap,i}=(1/(1-X))*Z for inter-frequency type B measurement, where Z is the number of configured type B MOs without MG that are being measured outside of MG and X is the searcher resource sharing factor between type A and type B. In some implementations, for example, X can be equal to 50%.

In some implementations, the value of X used for setting the value of the CSSF_{outside_gap_RedCap,i} in the second configuration can be preconfigured by the network via signaling received, for example, from a gNodeB.

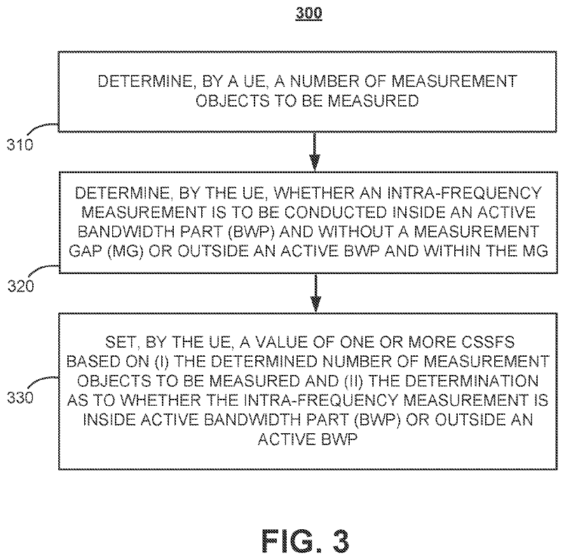

FIG. 3 is a flowchart of a process 300 for deriving one or more carrier-specific scaling factors (CSSFs) for intrafrequency or interfrequency SSB-based measurement. For convenience, the process 300 will be described as being performed by a UE.

A UE can begin execution of the process 300 by determining, by the UE, a number of measurement objects to be measured (310). In some implementations, the UE's determination at stage 310 can include determining that only one measurement object is configured to be measured outside of MG for RedCap. In other implementations, the UE's determination at stage 310 can include determining that multiple measuring objects are to be measured outside of MG or with MG.

A UE can continue execution of the process 300 by determining, by the UE, whether an intra-frequency measurement is inside active bandwidth part (BWP)/without MG or outside an active BWP/within MG (320). In some implementations, the UE's execution of stage 320 can include determining that the intra-frequency measurement is inside the active BWP or without MG. In other implementations, the UE's execution of stage 320 can include determining that the intra-frequency measurement is outside the active BWP or with MG;

A UE can continue execution of the process 300 by setting, by the UE, a value of one or more CSSFs based on (i) the determined number of measurement objects to be measured and (ii) the determination as to whether the intra-frequency measurement is inside the active BWP/without MG or outside the active BWP/within MG (330).

In some implementations, the UE's execution of stage 330 can include based on a determination at stage 310 that only one measurement object is to be measured outside of MG, setting the value of one CSSF equal to 1.

In some implementations, the UE's execution of stage 330 can include based on a determination stage 320, by the UE, that the intra-frequency measurement is inside the active BWP/without MG, (i) setting the value of a first CSSF to 2 for the intra-frequency measurement and (ii) setting the value of a second CSSF to 2*Y for interfrequency measurement with no measurement gap, where Y is the number of interfrequency measurement objects without MG that are being measured outside of MG. In such implementations, the number of interfrequency measurement objects without MG that are being measured outside of MG include (i) interfrequency measurement without MG with capability measurement objects and (ii) interfrequency measurement without MG without capability measurement objects.

In some implementations, the UE's execution of stage 330 can include based on a determination stage 320, by the UE, that the intra-frequency measurement is outside the active BWP/with MG, setting the value of one CSSF to Y for interfrequency measurement with no measurement gap, where Y is the number of interfrequency measurement objects without MG that are being measured outside of MG. In such implementations, the number of interfrequency measurement objects without MG that are being measured outside of MG include (i) interfrequency measurement without MG with capability measurement objects and (ii) interfrequency measurement without MG without capability measurement objects.

In some implementations, the UE's execution of stage 330 can include based on a determination stage 320, by the UE, that the intra-frequency measurement is inside the active BWP/without MG, (i) setting the value of a first CSSF to 2 for the intra-frequency measurement, (ii) setting the value of a second CSSF to 2*(1/X)*Y for interfrequency measurement without measurement gap with capability, where Y is the number of interfrequency measurement objects without MG with capability that are being measured outside of MG, and (iii) setting the value of a third CSSF to 2*(1/(1-X))*Z for inter-frequency without MG without capability, where Z is the number of interfrequency measurement objects without MG without capability that are being measured outside of MG, where X is a resource sharing factor between (a) interfrequency measurements of measurement objects without MG with capability and (b) interfrequency measurement of measurement objects without MG without capability.

In some implementations, the UE's execution of stage 330 can include based on a determination stage 320, by the UE, that the intra-frequency measurement is outside the active BWP/with MG, (i) setting the value of a first CSSF to (1/X)*Y for interfrequency measurement without measurement gap with capability, where Y is the number of interfrequency measurement objects without MG with capability that are being measured outside of MG, and (iii) setting the value of a second CSSF to (1/1-X))*Z for inter-frequency without MG without capability, where Z is the number of interfrequency measurement objects without MG without capability that are being measured outside of MG, where X is a resource sharing factor between (a) interfrequency measurements of measurement objects without MG with capability and (b) interfrequency measurement of measurement objects without MG without capability.

In some implementations, X is equal to 0.5. In some implementations, X is preconfigured via signaling received from a gNodeB.

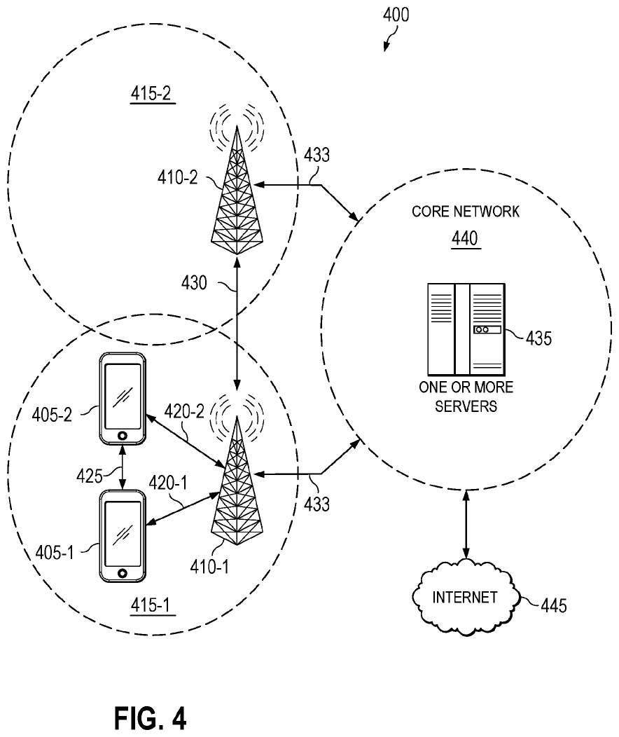

FIG. 4 is a diagram of an example of a wireless communication system 400, according to some implementations. It is noted that the system of FIG. 4 is merely one example of a possible system, and that features of this disclosure may be implemented in other wireless communication systems.

The following description is provided for an example communication system 400 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G)) systems). While aspects may be described herein using terminology commonly associated with 5G NR, aspects of the present disclosure can be applied to other systems, such as 4G and/or systems subsequent to 5G (e.g., 6G).

As shown, the communication system 400 includes a number of user devices. As used herein, the term “user devices” may refer generally to devices that are associated with mobile actors or traffic participants in the communication system 400, e.g., mobile (able-to-move) communication devices such as vehicles and pedestrian user equipment (PUE) devices. More specifically, the V2X communication system 400 includes two UEs 405 (UE 405-1 and UE 405-2 are collectively referred to as “UE 405” or “UEs 405”), two base stations 410 (base station 410-1 and base station 410-2 are collectively referred to as “base station 410” or “base stations 410”), two cells 415 (cell 415-1 and cell 415-2 are collectively referred to as “cell 415” or “cells 415”), and one or more servers 435 in a core network (CN) 440 that is connected to the Internet 445.

As shown, certain user devices may be able to conduct communications with one another directly, i.e., without an intermediary infrastructure device such as base station 410-1. As shown, UE 405-1 may conduct communications (e.g., V2X-related communications) directly with UE 405-2. Similarly, the UE 405-2 may conduct communications directly with UE 405-2. Such peer-to-peer communications may utilize a “sidelink” interface such as a PC5 interface. In certain implementations, the PC5 interface supports direct cellular communication between user devices (e.g., between UEs 405), while the Uu interface supports cellular communications with infrastructure devices such as base stations. For example, the UEs 405 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCHI), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 405 may be physical hardware devices capable of running one or more applications, capable of accessing network services via one or more radio links 420 with a corresponding base station 410, and capable of communicating with one another via sidelink 425. Link 420 may allow the UEs 405 to transmit and receive data from the base station 410 that provides the link 420. The sidelink 425 may allow the UEs 405 to transmit and receive data from one another. The sidelink 425 between the UEs 405 may include one or more channels for transmitting information from UE 405-1 to UE 405-2 and vice versa and/or between UEs 405 and UE-type RSUs (not shown in FIG. 4) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1^{st} SCI for the purpose of sensing and broadcast communication, and the 2^{nd} SCI carrying the remaining information for data scheduling of unicast/groupcast data transmission.

In some implementations, the sidelink 425 is established through an initial beam pairing procedure. In this procedure, the UEs 405 identify (e.g., using a beam selection procedure) one or more potential beam pairs that could be used for the sidelink 425. A beam pair includes a transmitter beam from a transmitter UE (e.g., UE 405-1) to a receiver UE (e.g., UE 405-2) and a receiver beam from the receiver UE to the transmitter UE. In some examples, the UEs 405 rank the one or more potential beam pairs. Then, the UEs 405 select one of the one or more potential beam pairs for the sidelink 425, perhaps based on the ranking

As stated, the air interface between two or more UEs 405 or between a UE 405 and a UE-type RSU (not shown in FIG. 4) may be referred to as a PC5 interface. To transmit/receive data to/from one or more eNBs 410 or UEs 405, the UEs 405 may include a transmitter/receiver (or alternatively, a transceiver), memory, one or more processors, and/or other like components that enable the UEs 405 to operate in accordance with one or more wireless communications protocols and/or one or more cellular communications protocols. The UEs 405 may have multiple antenna elements that enable the UEs 405 to maintain multiple links 420 and/or sidelinks 425 to transmit/receive data to/from multiple base stations 410 and/or multiple UEs 405. For example, as shown in FIG. 4, UE 405 may connect with base station 410-1 via link 420 and simultaneously connect with UE 405-2 via sidelink 425.

In some implementations, the UEs 405 are configured to use a resource pool for sidelink communications. A sidelink resource pool may be divided into multiple time slots, frequency channels, and frequency sub-channels. In some examples, the UEs 405 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 400 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 405 are configured to perform sidelink beam failure recovery procedures. The V2X communication system 400 can enable or disable support of the sidelink beam failure recovery procedures in the UEs 405. More specifically, the V2X communication system 400 can enable or disable support per resource pool or per PC5-RRC configuration (which may depend on UE capability). In the sidelink beam failure recovery procedures, one of the UEs 405 is designated as a transmitter UE (e.g., UE 405-1) and the other UE is designated as a receiver UE (e.g., UE 405-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

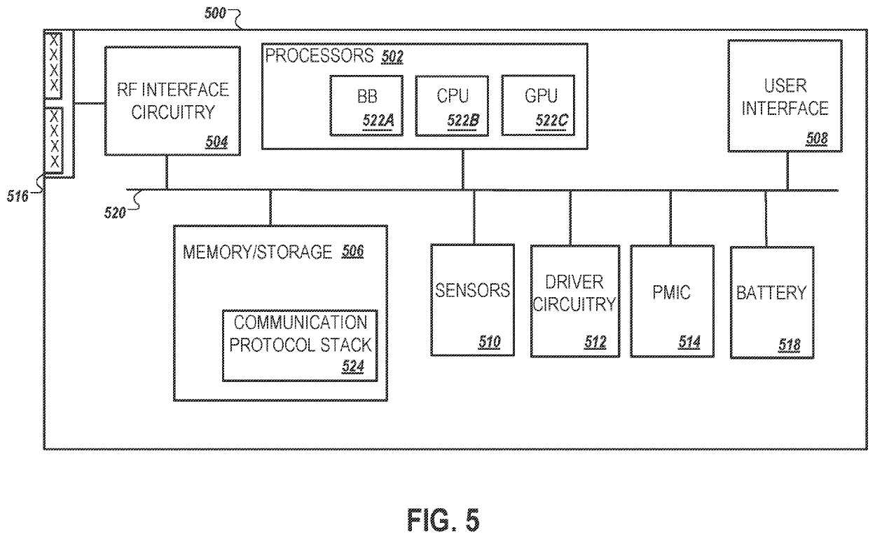

FIG. 5 is a block diagram of an example of user equipment (UE). The UE 500 may be similar to and substantially interchangeable with UEs 405 of FIG. 4.

The UE 500 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, one or more antennas 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM”in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the one or more antennas 516.

In various implementations, the RF interface circuitry 504 may be configured to transmit/receive signals in a manner compatible with NR access technologies.

The one or more antennas 516 may include antenna elements to convert electrical signals into radio waves to travel through the air and to convert received radio waves into electrical signals. The antenna elements may be arranged into one or more antenna panels. The one or more antennas 516 may have antenna panels that are omnidirectional, directional, or a combination thereof to enable beamforming and multiple input, multiple output communications. The one or more antennas 516 may include microstrip antennas, printed antennas fabricated on the surface of one or more printed circuit boards, patch antennas, phased array antennas, etc. The one or more antennas 516 may have one or more panels designed for specific frequency bands including bands in FRI or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500 including DRX as discussed herein. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

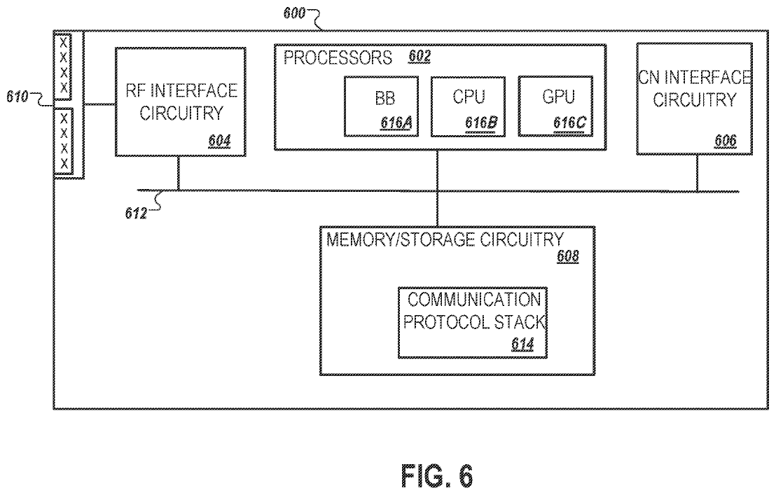

FIG. 6 is a block diagram of an example of an access node. FIG. 6 illustrates an access node 600 (e.g., a base station or gNB), in accordance with some implementations. The access node 600 may be similar to and substantially interchangeable with base stations 410 of FIG. 4. The access node 600 may include processors 602, RF interface circuitry 604, core network (CN) interface circuitry 606, memory/storage circuitry 608, and one or more antennas 610.

The components of the access node 600 may be coupled with various other components over one or more interconnects 612. The processors 602, RF interface circuitry 604, memory/storage circuitry 608 (including communication protocol stack 614), one or more antennas 610, and interconnects 612 may be similar to like-named elements shown and described with respect to FIG. 6. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 600; a MAC/PHY split wherein RRC, PDCP, RLC, and MAC layers are operated by the CRAN/vBBUP and the PHY layer is operated by the access node 600; or a “lower PHY” split wherein RRC, PDCP, RLC, MAC layers and upper portions of the PHY layer are operated by the CRAN/vBBUP and lower portions of the PHY layer are operated by the access node 600.

In V2X scenarios, the access node 600 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

### EXAMPLES

In the following section, further exemplary embodiments are provided.

Example 1 includes one or more processors of a user equipment (UE), the one or more processors configured to cause the UE to perform operations for reference synchronization signal/physical broadcast channel block (SSB) signal measurement, the operations including: determining whether a level of SSB block measurement timing configuration (SMTC) overlap for inter-frequency measurement without measurement gap (MG) without capability is (i) partially overlapped or (ii) fully non-overlapped with a MG configured by a serving cell; and determining whether to perform inter-frequency measurement without measurement gap (MG) without capability within the MG or outside of the MG based on the determined level of SMTC overlap with the MG configured by the serving cell.

Example 2 is the one or more processors of Example 1, the operations further including: determining that the level of SMTC overlap is partially overlapped with the MG configured by the serving cell; and based on the determination that the level of SMTC overlap is partially overlapped with the MG configured by the serving cell, performing inter-frequency measurement without measurement gap (MG) without capability within the MG.

Example 3 is the one or more processors of Example 1, the operations further including: determining that the level of SMTC overlap is partially overlapped with MG configured by the serving cell; and based on the determination that the level of SMTC overlap is partially overlapped with the MG configured by the serving cell, performing inter-frequency measurement without measurement gap (MG) without capability outside the MG.

Example 4 is the one or more processors of Example 1, the operations further including: determining that the level of SMTC overlap is partially overlapped with the MG configured by the serving cell; and based on the determination that the level of SMTC overlap is partially overlapped with the MG configured by the serving cell, determining whether a flag indicating whether the UE is configured to perform inter-frequency measurement without gap is activated; and based on the determination that the flag indicating whether the UE is configured to perform inter-frequency measurement without gap is activated, performing inter-frequency measurement without measurement gap (MG) without capability outside the MG.

Example 5 is the one or more processors of Example 1, the operations further including: determining that the level of SMTC overlap is partially overlapped with the MG configured by the serving cell; and based on the determination that the level of SMTC overlap is partially overlapped with the MG configured by the serving cell, determining whether a flag indicating whether the UE is configured to perform inter-frequency measurement without gap is not activated; and based on the determination that the flag indicating whether the UE is configured to perform inter-frequency measurement without gap not activated, performing inter-frequency measurement without measurement gap (MG) without capability within the MG.

Example 6 is the one or more processors of Example 1, the operations further including: determining that the level of SMTC overlap is partially overlapped with the MG configured by the serving cell; and based on the determination that the level of SMTC overlap is partially overlapped with the MG configured by the serving cell, determining whether an interFrequencyConfig-NoGap for interfrequency measurement without MG without capability value is activated; and based on the determination that the interFrequencyConfig-NoGap for interfrequency measurement without MG without capability value is activated, performing inter-frequency measurement without measurement gap (MG) without capability outside the MG.

Example 7 is the one or more processors of Example 1, the operations further including: determining that the level of SMTC overlap is partially overlapped with the MG configured by the serving cell; and based on the determination that the level of SMTC overlap is partially overlapped with the MG configured by the serving cell, determining whether an interFrequencyConfig-NoGap for interfrequency measurement without MG without capability value is not activated; and based on the determination that the interFrequencyConfig-NoGap for interfrequency measurement without MG without capability value is not activated, performing inter-frequency measurement without measurement gap (MG) without capability within the MG.

Example 8 is the one or more processors of Example 1, the operations further including: determining that the level of SMTC overlap is fully non-overlapped with the MG configured by the serving cell; and based on the determination that the level of SMTC overlap is fully non-overlapped with the MG configured by the serving cell, immediately performing inter-frequency measurement without measurement gap (MG) without capability.

Example 9 is the one or more processors of Example 1, the operations further including: determining that the level of SMTC overlap is fully non-overlapped with the MG configured by the serving cell; and based on the determination that the level of SMTC overlap is fully non-overlapped with the MG configured by the serving cell, delaying performance of inter-frequency measurement without measurement gap (MG) without capability until the network reconfigures the SMTC to partially overlapped or fully overlapped with MG.

Example 10 is the one or more processors of Example 1, the operations further including: determining that the level of SMTC overlap is fully non-overlapped with the MG configured by the serving cell; and based on the determination that the level of SMTC overlap is fully non-overlapped with the MG configured by the serving cell, determining whether a flag indicating whether the UE is configured to perform inter-frequency measurement without gap is activated; and based on the determination that the flag indicating whether the UE is configured to perform inter-frequency measurement without gap is activated, immediately performing inter-frequency measurement without measurement gap (MG) without capability.

Example 11 is the one or more processors of Example 1, the operations further including: determining that the level of SMTC overlap is fully non-overlapped with the MG configured by the serving cell; and based on the determination that the level of SMTC overlap is fully non-overlapped with the MG configured by the serving cell, determining, by the RedCap UE, whether a flag indicating whether the UE is configured to perform inter-frequency measurement without gap is not activated; and based on the determination that the flag indicating whether the UE is configured to perform inter-frequency measurement without gap is not activated, delaying performance, by the RedCap UE, of inter-frequency measurement without measurement gap (MG) without capability until the network reconfigures the SMTC to partially overlapped or fully overlapped with MG.

Example 12 is the one or more processors of Example 1, the operations further including: determining that the level of SMTC overlap is fully non-overlapped with the MG configured by the serving cell; and based on the determination that the level of SMTC overlap is fully non-overlapped with the MG configured by the serving cell, determining, by the RedCap UE, whether an interFrequencyConfig-NoGap for interfrequency measurement without MG without capability value is activated; and based on the determination that the interFrequencyConfig-NoGap for interfrequency measurement without MG without capability value is activated, immediately performing inter-frequency measurement without measurement gap (MG) without capability.

Example 13 is the one or more processors of Example 1, the operations further including: determining that the level of SMTC overlap is fully non-overlapped with the MG configured by the serving cell; and based on the determination that the level of SMTC overlap is fully non-overlapped with the MG configured by the serving cell, determining whether an interFrequencyConfig-NoGap for interfrequency measurement without MG without capability value is not activated; and based on the determination that the interFrequencyConfig-NoGap for interfrequency measurement without MG without capability value is not activated, delaying performance of inter-frequency measurement without measurement gap (MG) without capability until the network reconfigures the SMTC to partially overlapped or fully overlapped with MG.

Example 14 is the one or more processors of Example 4, where the flag indicating whether the UE is configured to perform inter-frequency measurement without gap is an interFrequencyConfig-NoGap flag.

Example 15 may include a user equipment (UE) including the one or more processors of any of Examples 1-14.

Example 16 may include a non-transitory computer readable medium storing instructions that, when executed by one or more processors, cause the one or more processors to perform the operations of any of Examples 1-14.

Example 17 may include a method for performing the operations of any of Examples 1-14.

Example 18 may include an apparatus including logic, modules, or circuitry to perform one or more elements of the operations described in or related to any of Examples 1-14, or any other operations or process described herein.

Example 19 may include a method, technique, or process as described in or related to the operations of any of Examples 1-14, or portions or parts thereof.

Example 20 may include an apparatus including: one or more processors and one or more computer-readable media including instructions that, when executed by the one or more processors, cause the one or more processors to perform the method, techniques, or process as described in or related to the operations of any of Examples 1-14, or portions or parts thereof.

Example 21 may include a computer program including instructions, where execution of the program by a processing element is to cause the processing element to carry out the method, techniques, or process as described in or related to the operations of any of Examples 1-14, or portions or parts thereof. The operations or actions performed by the instructions executed by the processing element can include the operations of any one of Examples 1-14.

Example 22 may include a method of communicating in a wireless network as shown and described herein.

Example 23 may include a system for providing wireless communication as shown and described herein. The operations or actions performed by the system can include the operations of any one of Examples 1-14.

Example 24 may include a device for providing wireless communication as shown and described herein. The operations or actions performed by the device can include the operations of any one of Examples 1-14.

The previously-described operations of Examples 1-14 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-17. (canceled)

18. One or more processors configured to, when executing instructions stored in a memory, perform operations comprising:
determining that part of a first synchronization signal block (SSB) measurement timing configuration (SMTC) occasion for a first inter-frequency measurement with no measurement gap (MG) overlaps with a first MG;
performing the first inter-frequency measurement with no MG outside of the first MG based at least on the determined overlap between the first SMTC occasion and the first MG; and
in response to determining that a second SMTC occasion is fully non-overlapped with a second MG, delaying a second inter-frequency measurement with no MG until the second SMTC occasion is reconfigured to overlap with the second MG.

19. The one or more processors of claim 18, the operations further comprising instructing radio frequency (RF) circuitry to transmit control signaling that indicates a capability of a user equipment (UE) to perform inter-frequency SSB-based measurements with no MG.

20. The one or more processors of claim 18, the operations further comprising:
determining that a third SMTC occasion is partially overlapped with a third MG; and
based on the determination that the third SMTC occasion is partially overlapped with the third MG, performing a third inter-frequency measurement with no MG within the third MG.

21. The one or more processors of claim 18, the operations further comprising:
determining that the first SMTC occasion is partially overlapped with the first MG; and
based on the determination that the first SMTC occasion is partially overlapped with the first MG, performing the first inter-frequency measurement with no MG outside of the first MG.

22. The one or more processors of claim 18, the operations further comprising:
determining that the first SMTC occasion is partially overlapped with the first MG; and
based on the determination that the first SMTC occasion is partially overlapped with the first MG, determining that a flag indicating whether to perform inter-frequency measurement with no MG is activated; and
based on the determination that the flag indicating whether to perform inter-frequency measurement with no MG is activated, performing the first inter-frequency measurement with no MG outside of the first MG.

23. The one or more processors of claim 22, wherein the flag indicating whether to perform inter-frequency measurement with no MG is an interFrequencyConfig-NoGap flag.

24. The one or more processors of claim 18, the operations further comprising:
determining that a third SMTC occasion is partially overlapped with a third MG; and
based on the determination that the third SMTC occasion is partially overlapped with the third MG, determining that a flag indicating whether to perform inter-frequency measurement with no MG is not activated; and
based on the determination that the flag indicating whether to perform inter-frequency measurement with no MG not activated, performing a third inter-frequency measurement with no MG within the third MG.

25. The one or more processors of claim 18, the operations further comprising:
determining that the first SMTC occasion is partially overlapped with the first MG; and
based on the determination that the first SMTC occasion is partially overlapped with the first MG, determining whether an interFrequencyConfig-NoGap value is activated for inter-frequency measurement with no MG; and
based on the determination that the interFrequencyConfig-NoGap value is activated, performing the first inter-frequency measurement with no MG outside of the first MG.

26. The one or more processors of claim 18, the operations further comprising:
determining that a third SMTC occasion is partially overlapped with a third MG; and
based on the determination that the third SMTC occasion is partially overlapped with the third MG, determining whether an interFrequencyConfig-NoGap value is not activated for inter-frequency measurement with no MG; and
based on the determination that the interFrequencyConfig-NoGap value is not activated, performing a third inter-frequency measurement with no MG within the third MG.

27. The one or more processors of claim 18, the operations further comprising:
determining that a third SMTC occasion is fully non-overlapped with a third MG; and
based on the determination that the third SMTC occasion is fully non-overlapped with the third MG, performing a third inter-frequency measurement with no MG.

28. The one or more processors of claim 18, the operations further comprising:
determining that a third SMTC occasion is fully non-overlapped with a third MG; and
based on the determination that the third SMTC occasion is fully non-overlapped with the third MG, determining that a flag indicating whether to perform inter-frequency measurement with no MG is activated; and
based on the determination that the flag indicating whether to perform inter-frequency measurement with no MG is activated, performing a third inter-frequency measurement with no MG.

29. The one or more processors of claim 18, the operations further comprising:
determining that the second SMTC occasion is fully non-overlapped with the second MG; and
based on the determination that the second SMTC occasion is fully non-overlapped with the second MG, determining that a flag indicating whether to perform inter-frequency measurement with no MG is not activated; and
based on the determination that the flag indicating whether to perform inter-frequency measurement with no MG is not activated, delaying performance of the second inter-frequency measurement with no MG until the second SMTC occasion is reconfigured to partially or fully overlap with the second MG.

30. The one or more processors of claim 18, the operations further comprising:
determining that a third SMTC occasion is fully non-overlapped with a third MG; and
based on the determination that the third SMTC occasion is fully non-overlapped with the third MG, determining that an interFrequencyConfig-NoGap value is activated for inter-frequency measurement with no MG; and
based on the determination that the interFrequencyConfig-NoGap value is activated, performing a third inter-frequency measurement with no MG.

31. The one or more processors of claim 18, the operations further comprising:
determining that the second SMTC occasion is fully non-overlapped with the second MG; and
based on the determination that the second SMTC occasion is fully non-overlapped with the second MG, determining that an interFrequencyConfig-NoGap value is not activated for inter-frequency measurement with no MG; and
based on the determination that the interFrequencyConfig-NoGap value is not activated for inter-frequency measurement with no MG, delaying performance of the second inter-frequency measurement with no MG until the second SMTC occasion is reconfigured to partially or fully overlap with the second MG.

32. A method comprising:
determining that part of a first synchronization signal block (SSB) measurement timing configuration (SMTC) occasion for a first inter-frequency measurement with no measurement gap (MG) overlaps with a first MG;
performing the first inter-frequency measurement with no MG outside of the first MG based at least on the determined overlap between the first SMTC occasion and the first MG; and
in response to determining that a second SMTC occasion is fully non-overlapped with a second MG, delaying a second inter-frequency measurement with no MG until the second SMTC occasion is reconfigured to overlap with the second MG.

33. The method of claim 32, further comprising transmitting control signaling that indicates a capability of a user equipment (UE) to perform inter-frequency SSB-based measurements with no MG.

34. The method of claim 32, further comprising:
determining that a third SMTC occasion is partially overlapped with a third MG; and
based on the determination that the third SMTC occasion is partially overlapped with the third MG, performing a third inter-frequency measurement with no MG within the third MG.

35. The method of claim 32, further comprising:
determining that the first SMTC occasion is partially overlapped with the first MG; and
based on the determination that the first SMTC occasion is partially overlapped with the first MG, performing the first inter-frequency measurement with no MG outside of the first MG.

36. The method of claim 32, further comprising:
determining that the first SMTC occasion is partially overlapped with the first MG; and
based on the determination that the first SMTC occasion is partially overlapped with the first MG, determining that a flag indicating whether to perform inter-frequency measurement with no MG is activated; and
based on the determination that the flag indicating whether to perform inter-frequency measurement with no MG is activated, performing the first inter-frequency measurement with no MG outside of the first MG.

37. A user equipment (UE) comprising:
one or more processors; and
memory storing instructions that, when executed by the one or more processors, cause the UE to perform operations comprising:
determining that part of a first synchronization signal block (SSB) measurement timing configuration (SMTC) occasion for a first inter-frequency measurement with no measurement gap (MG) overlaps with a first MG;
performing the first inter-frequency measurement with no MG outside of the first MG based at least on the determined overlap between the first SMTC occasion and the first MG; and
in response to determining that a second SMTC occasion is fully non-overlapped with a second MG, delaying a second inter-frequency measurement with no MG until the second SMTC occasion is reconfigured to overlap with the second MG.
